(19) United States
(12) Patent Application Publication
(10) Pub. No.: US 2011/0254874 A1
(43) Pub. Date: Oct. 20, 2011

(54) IMAGE PROCESSING APPARATUS, DISPLAY SYSTEM, ELECTRONIC APPARATUS AND METHOD OF PROCESSING IMAGE

(75) Inventor: Kazuto KIKUTA, Hachioji-shi (JP)

(73) Assignee: SEIKO EPSON CORPORATION, TOKYO (JP)

(21) Appl. No.: 13/084,083

(22) Filed: Apr. 11, 2011

(30) Foreign Application Priority Data
Apr. 15, 2010 (JP) 2010-093762

(51) Int. Cl. G09G 5/10

(52) U.S. Cl. 345/690

(57) ABSTRACT

An image processing apparatus performing display control based on image data corresponding to each of pixels forming a display image includes an image data correcting section correcting the image data of each pixel based on information corresponding to an operating current of each pixel and a display control section compensating for the steps of gradation lost by image data correction by adjusting the lighting time of each pixel.

The entire disclosure of Japanese Patent Application No. 2010-093762, filed Apr. 15, 2010, is expressly incorporated by reference herein.

### BACKGROUND

1. Technical Field

An aspect of the present invention relates to image processing apparatuses, display systems, electronic apparatuses, methods of processing an image.

2. Related Art

In recent years, as a display element, an LCD (Liquid Crystal Display: LCD) panel using a liquid crystal element and a display panel (a display unit) using an organic light emitting diode (Organic Light Emitting Diode: hereinafter abbreviated as an OLED) (in a broad sense, a light emitting device) have become widespread. In particular, the OLED responses faster than the liquid crystal element and can increase the contrast ratio. The display panel in which such OLEDs are arranged in a matrix has a wide viewing angle and can display a high-quality image.

However, in the display panel using the OLED, since different organic materials are used for different color components forming one pixel, variations occur in the degrees of deterioration of brightness after use, resulting in a reduction in image quality due to nonuniform brightness and color unevenness. Moreover, in the display panel using the OLED, nonuniform brightness and color unevenness caused by production also become factors that reduce production yields and hamper cost reduction.

Techniques of correcting such nonuniform brightness and color unevenness of the OLED are disclosed in JP-T-2005-530203 (Patent Document 1) and JP-A-2007-65015 (Patent Document 2), for example. In Patent Document 1, a driver circuit that performs control according to external factors such as the temperature, the life of a display panel, and current drive changes by controlling a power supply voltage to a constant-current power source driving a display element is disclosed. Moreover, in Patent Document 2, a main control circuit that generates a gradation histogram for each frame by analyzing input pixel data of each color component, obtains the total sum of brightness based on the histograms, and corrects the pixel data by using the total sum is disclosed.

However, nonuniform brightness and color unevenness are caused by variations in the light emitting element itself and variations in the drive current driving the light emitting element. Therefore, with the techniques disclosed in Patent Document 1 and Patent Document 2, it is impossible to correct variations in the light emitting element itself and variations in the drive current driving the light emitting element concurrently and reduce nonuniform brightness and color unevenness of the display panel using OLED with a high degree of accuracy. Moreover, if nonuniform brightness and color unevenness are simply corrected, gradation loss occurs by which only a few steps of gradation are lost, for example. This reduces the number of steps of gradation which can be used for expression and makes it impossible to obtain a high-quality image.

### SUMMARY

The invention has been made in view of the technical problems described above. According to some aspects of the invention, it is possible to provide an image processing apparatus, a display system, an electronic apparatus, a method of processing an image, etc. which compensate for a gradation loss occurring when variations in a display element and a drive current driving the display element are corrected concurrently.

(1) According to an aspect of the invention, an image processing apparatus performing display control based on image data corresponding to each of pixels forming a display image includes: an image data correcting section correcting the image data of each pixel based on information corresponding to an operating current of each pixel; and a display control section compensating for the steps of gradation lost by correction performed by the image data correcting section by adjusting the lighting time of each pixel.

According to this aspect, by correcting the corresponding image data based on the operating current value of the pixel, it is possible to correct variations in a display element and a drive current driving the display element concurrently and reduce nonuniform brightness and color unevenness with a high degree of accuracy. Moreover, since the steps of gradation lost by correction of the image data are compensated for by adjusting the lighting time of the pixel, it is possible to compensate for so-called gradation loss and compensate for the shortage of steps of gradation.

(2) In the image processing apparatus according to another aspect of the invention, the display control section adjusts the lighting time of the pixel according to the image data corrected by the image data correcting section.

According to this aspect, since the lighting time of the pixel is adjusted based on the corrected image data, it is possible to compensate for gradation loss according to the degree of correction of the image data and compensate for the shortage of steps of gradation. This makes it possible to perform higher-definition gradation display.

(3) In the image processing apparatus according to another aspect of the invention, the display control section outputs image data corresponding to a first gradation value in a first frame corresponding to the image data corrected by the image data correcting section and outputs image data corresponding to a second gradation value in a second frame.

In this aspect, image data corresponding to a first gradation value is output in a first frame corresponding to the image data corrected by the image data correcting section, and image data corresponding to a second gradation value is output in a second frame corresponding to the image data corrected by the image data correcting section. This makes it possible to perform detailed lighting control of pixels with simple processing and perform higher-definition gradation display by compensating for the steps of gradation lost by correction.

(4) In the image processing apparatus according to another aspect of the invention, the display control section includes a frame rate table storing section storing a frame rate table in which a frame to be lit is set according to a frame rate corresponding to the image data corrected by the image data correcting section, and the display control section performs lighting control of the pixel based on the frame rate table.

According to this aspect, since a frame rate table is provided and lighting control of the pixel is performed according to the frame rate table, it is possible to correct variations in a display element and a drive current driving the display element concurrently with simple control and compensate for gradation loss caused by the correction.

(5) In the image processing apparatus according to another aspect of the invention, the frame rate table storing section stores the frame rate table for each of color components forming one dot, and the display control section performs lighting control of a pixel of each color component based on the frame rate table stored for each color component.

According to this aspect, since the frame rate table is provided for each color component, higher-definition gradation expression is made possible by compensating for the steps of gradation by gradation loss which differs from color component to color component.

(6) In the image processing apparatus according to another aspect of the invention, the image data correcting section corrects the image data of each pixel on the basis of difference information based on a minimum operating current of operating currents of the pixels in one screen.

According to this aspect, in addition to the above-described effects, it is possible to reduce the amount of information and reduce the correction information storage capacity.

(7) In the image processing apparatus according to another aspect of the invention, the display control section compensates for the steps of gradation lost by correction of the image data performed by the image data correcting section when the display image is a still image.

According to this aspect, in addition to the above-described effects, it is possible to prevent deterioration of image quality of moving images by not performing control on moving images and improve the image quality at the time of image display at which the lighting time becomes longer.

(8) According to another aspect of the invention, a display system includes: a display panel including a plurality of row signal lines, a plurality of column signal lines provided so as to intersect the plurality of row signal lines, and a plurality of pixels, each having a light emitting element which is identified by any one of the plurality of row signal lines and any one of the plurality of column signal lines and emits light at brightness according to a drive current; a row driver driving the plurality of row signal lines; a column driver driving the plurality of column signal lines; and the image processing apparatus described in any one of the above aspects, wherein the display system displays the display image based on the image data on which display control has been performed by the image processing apparatus.

According to this aspect, it is possible to compensate for gradation loss occurring when variations in a display element and a drive current driving the display element are corrected concurrently, reduce nonuniform brightness and color unevenness with a high degree of accuracy, and provide a display system which can perform higher-definition gradation display.

(9) According to another aspect of the invention, an electronic apparatus includes the image processing apparatus described in any one of the above aspects.

According to this aspect, it is possible to compensate for gradation loss occurring when variations in a display element and a drive current driving the display element are corrected concurrently, reduce nonuniform brightness and color unevenness with a high degree of accuracy, and provide an electronic apparatus which can perform higher-definition gradation display.

(10) According to another aspect of the invention, a method of processing an image, the method by which display control is performed based on image data corresponding to each of pixels forming a display image, includes: an image data correcting step of correcting the image data of each pixel based on information corresponding to an operating current of each pixel; and a display control step of compensating for the steps of gradation lost by correction of the image data performed in the image data correcting step by adjusting the lighting time of each pixel.

According to this aspect, by correcting the corresponding image data based on the operating current value of the pixel, it is possible to correct variations in a display element and a drive current driving the display element concurrently and reduce nonuniform brightness and color unevenness with a high degree of accuracy. Moreover, since the steps of gradation lost by correction of the image data are compensated for by adjusting the lighting time of each pixel, it is possible to compensate for so-called gradation loss and compensate for the shortage of steps of gradation.

(11) In the method of processing an image according to another aspect of the invention, in the display control step, lighting control of the pixel is performed according to the image data corrected in the image data correcting step.

According to this aspect, since the lighting time of the pixel is adjusted based on the image data obtained after correction of the image data, it is possible to compensate for gradation loss which has occurred according to the degree of correction of the image data and compensate for the shortage of steps of gradation. This makes it possible to perform higher-definition gradation display.

(12) In the method of processing an image according to another aspect of the invention, in the display control step, image data corresponding to a first gradation value is output in a first frame corresponding to the image data corrected in the image data correcting step, and image data corresponding to a second gradation value is output in a second frame.

In this aspect, image data corresponding to a first gradation value is output in a first frame corresponding to the image data corrected by the image data correcting section, and image data corresponding to a second gradation value is output in a second frame corresponding to the image data corrected by the image data correcting section. This makes it possible to perform detailed lighting control of pixels with simple processing and perform higher-definition gradation display by compensating for the steps of gradation lost by correction.

### BRIEF DESCRIPTION OF THE DRAWINGS

FIG. 1 shows a block diagram of a configuration example of a display system according to an embodiment of the invention.

FIG. 2 shows a circuit diagram of a configuration example of a pixel circuit of FIG. 1.

FIG. 3 shows a block diagram of a configuration example of an image processing apparatus of FIG. 1.

FIG. 4 shows a diagram showing a configuration example of a current measured value capturing section of FIG. 3.

FIG. 5 shows an explanatory diagram of an example of the operation of the current measured value capturing section of FIG. 4.

FIG. 6 shows a block diagram of a configuration example of a correction information generating section of FIG. 3.

FIG. 7 shows a block diagram of a configuration example of an FRC section of FIG. 3.

FIG. 8 shows a diagram for explaining the operation of the FRC section of FIG. 7.

FIG. 9 shows a diagram showing an outline of a frame rate table which is stored in a frame rate table storing section of FIG. 7.

FIG. 10 shows a flow diagram of an example of processing performed by the image processing apparatus.

FIGS. 11(A) and 11(B) are perspective views showing the configurations of electronic apparatuses to which the display system in this embodiment is applied.

### DETAILED DESCRIPTION OF EXEMPLARY EMBODIMENTS

Hereinafter, an embodiment of the invention will be described in detail by using the drawings. It is to be understood that the invention described in the claims is not unduly limited by the embodiment thereof described below. Moreover, all the configurations described below are not always the component elements necessary for solving the problems of the invention.

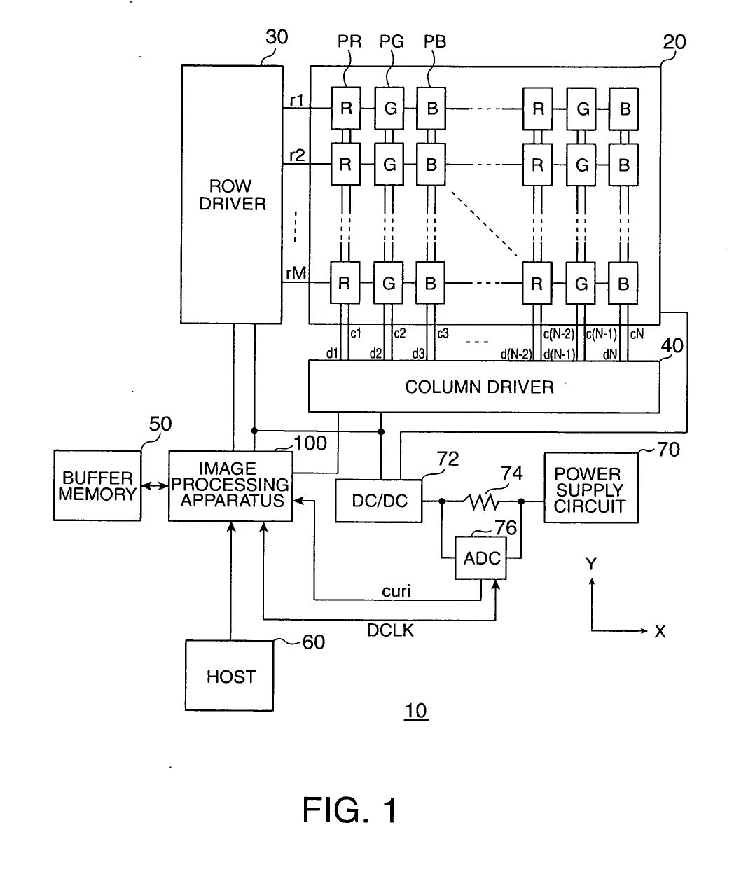

In FIG. 1, a block diagram of a configuration example of a display system according to an embodiment of the invention is shown. The display system has a display panel (a light emitting panel) using OLEDs, each being a light emitting element as a display element, and each OLED is driven by a row driver and a column driver based on image data and a display timing control signal which are generated by an image processing apparatus.

The display system 10 includes a display panel 20, a row driver 30, a column driver 40, a buffer memory 50, a power supply circuit 70, an image processing apparatus 100, and a host 60. Furthermore, the display system 10 includes a DC/DC converter 72, a resistance circuit 74, and an A/D converter (ADC) 76. In the display panel 20, a plurality of data signal lines d1 to dN (N is an integer greater than or equal to 2) and a plurality of column signal lines c1 to cN which extend in the Y direction are arranged in the X direction. Furthermore, in the display panel 20, a plurality of row signal lines r1 to rM (M is an integer greater than or equal to 2) extending in the X direction so as to intersect the column signal lines and the data signal lines are arranged in the Y direction. In the positions where the column signal lines (more specifically, the column signal lines and the data signal lines) and the row signal lines intersect each other, pixel circuits are formed, and a plurality of pixel circuits are arranged in a matrix in the display panel 20.

In FIG. 1, a pixel circuit PR of an R component, a pixel circuit PG of a G component, and a pixel circuit PB of a B component, which are neighboring pixel circuits in the X direction, form one dot. The pixel circuit PR of the R component has an OLED emitting a red display color, the pixel circuit PG of the G component has an OLED emitting a green display color, and the pixel circuit PB of the B component has an OLED emitting a blue display color.

The row driver 30 is connected to the row signal lines r1 to rM of the display panel 20. The row driver 30 selects the row signal lines r1 to rM of the display panel 20 one at a time within one vertical scanning period, for example, and outputs a selection pulse in a selection period of each row signal line. The column driver 40 is connected to the data signal lines d1 to dN and the column signal lines c1 to cN of the display panel 20. The column driver 40 applies a given power supply voltage to the column signal lines c1 to cN and applies a gradation voltage corresponding to the image data of one line to each data signal line in each horizontal scanning period, for example.

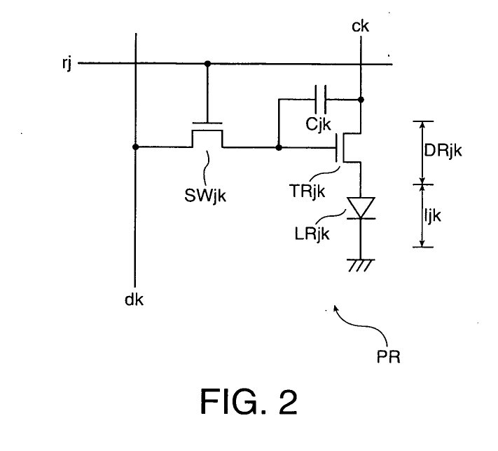

In FIG. 2, a circuit diagram of a configuration example of the pixel circuit PR of FIG. 1 is shown. Although a configuration example of an electrical equivalent circuit of the pixel circuit PR is shown in FIG. 2, the pixel circuit PG and the pixel circuit PB, which form one pixel together with the pixel circuit PR, also have the same configuration as that of FIG. 2. Moreover, the pixel circuits forming the other pixels of the display panel 20 of FIG. 1 also have the same configuration as that of FIG. 2.

The pixel circuit PR is formed in a position where a row signal line rj and a column signal line ck intersect. The pixel circuit PR includes a driving transistor TRjk, a switch transistor SWjk, a capacitor Cjk, and a light emitting element LRjk emitting a light of a red display color. To the gate of the switch transistor SWjk, the row signal line rj is connected, to the source of the switch transistor SWjk, it is connected to the data signal line dk, and, to the drain of the switch transistor SWjk, the gate of the driving transistor TRjk is connected. The source of the driving transistor TRjk is connected to the anode of the light emitting element LRjk, and the drain of the driving transistor TRjk is connected to the column signal line ck. The cathode of the light emitting element LRjk is grounded. Moreover, to the gate of the driving transistor TRjk, one end of the capacitor Cjk is connected, and, to the drain of the driving transistor TRjk, the other end of the capacitor Cjk is connected.

In such a configuration, in a horizontal scanning period in which the j (1≦j≦M, j is an integer)-th row is selected, a selection pulse is applied to the row signal line rj. Then, the switch transistor SWjk forming a pixel circuit in the k (1≦k≦N, k is an integer)-th column of the j-th row is brought into a conduction state, and a voltage corresponding to the image data, the voltage applied to the data signal line dk, is applied to the gate of the driving transistor TRjk. At this time, when a given power supply voltage is applied to the column signal line ck, the driving transistor TRjk is brought into a conduction state, and a drive current flows through the light emitting element LRjk. At this time, a light of a red display color is emitted from the light emitting element LRjk.

As described above, the display panel 20 includes a plurality of pixels, each having an OLED which is identified by any one of the plurality of row signal lines and any one of the plurality of column signal lines and emits light at brightness according to a drive current. Then, the row driver 30 and the column driver 40 can supply a drive current corresponding to the image data to OLEDs forming pixels connected to the row signal lines selected one at a time within one vertical scanning period.

In FIG. 1, as an image data generating section, the host 60 generates image data corresponding to a display image. The image data generated by the host 60 is sent to the image processing apparatus 100. The power supply circuit 70 generates a plurality of types of power supply voltages and supplies the power supply voltages to individual parts of the display panel 20, the row driver 30, the column driver 40, the image processing apparatus 100, etc.

In this embodiment, nonuniform brightness and color unevenness of an OLED are corrected by measuring the operating current value of each pixel including an OLED on a power line from the power supply circuit 70 and correcting the image data based on the operating current value. Nonuniform brightness and color unevenness are caused by variations in the light emitting element LRjk or variations in the drive current of the light emitting element LRjk in the pixel circuit PR shown in FIG. 2, for example. Here, variations in the light emitting element LRjk correspond to variations in a current Ijk flowing through the light emitting element LRjk, and variations in the drive current of the light emitting element LRjk correspond to variations in a drain current DRjk of the driving transistor TRjk. An operating current of each pixel depends not only on the characteristics of the OLED itself, for example, but also on the characteristics of a driving transistor for driving the OLED and a drive circuit driving the data signal line. Therefore, by correcting the image data based on the current value corresponding to the operating current of each pixel described above, it is possible to correct variations in an OLED and a drive current driving the OLED concurrently and thereby reduce nonuniform brightness and color unevenness with a high degree of accuracy.

Thus, the DC/DC converter 72 converts the level of the direct-current power supply voltage generated by the power supply circuit 70, and supplies the direct-current power supply voltage after conversion to the display panel 20, the row driver 30, the column driver 40, the image processing apparatus 100, etc. The resistance circuit 74 is inserted into a power line connecting the power supply circuit 70 and the DC/DC converter 72. The A/D converter 76 is connected in parallel with the resistance circuit 74, converts an analog current value flowing through the resistance circuit 74 into a digital current value curi in synchronization with a pixel clock DCLK, and outputs the digital current value curi to the image processing apparatus 100. As a result, every time a light emitting element is lit pixel by pixel in synchronization with the pixel clock DCLK, it is possible to capture the current value of the resistance circuit 74 inserted into the power line connected to the power supply circuit 70. This current value corresponds to the operating current value of the light emitting element forming one pixel described earlier.

To the image processing apparatus 100, the image data is supplied from the host 60. To the buffer memory 50, an operating current value (information corresponding to an operating current) which is a current value for driving each pixel of the display panel 20 is stored. The image processing apparatus 100 corrects the nonuniform brightness and color unevenness of an OLED by supplying, to the column driver 40, the image data corrected based on the operating current value read from the buffer memory 50. At this time, the image processing apparatus 100 performs processing for compensating for the steps of gradation by controlling the lighting time of the OLED by performing frame rate control (Frame Rate Control: hereinafter FRC) on the corrected image data to compensate for the steps of gradation lost by the above-described correction. Incidentally, the image processing apparatus 100 may incorporate storage means having the function of the buffer memory 50 without being provided with the buffer memory 50.

In FRC commonly used in an LCD, by switching pattern display of 4 dots×4 dots, for example, on a frame-by-frame basis, although display of only about 260 thousand colors is originally possible with 6 bits for each of RGB, display of about 16.77 million colors, for example, is made possible in a pseudo manner. This is made possible by using the residual image effect obtained by a low speed of response to fluctuations in the drive voltage in a liquid crystal element and the fact that a liquid crystal element is not self-luminous and a backlight is always lit. On the other hand, in this embodiment, since an element is self-luminous, by adjusting the lighting time, it is possible to compensate for a certain number of steps of gradation, making it possible to compensate for the shortage of steps of gradation.

The image data subjected to such FRC performed by the image processing apparatus 100 is supplied to the column driver 40. Moreover, the image processing apparatus 100 generates a display timing control signal corresponding to the image data. The image processing apparatus 100 supplies the display timing control signal corresponding to the image data subjected to FRC to the row driver 30 and the column driver 40.

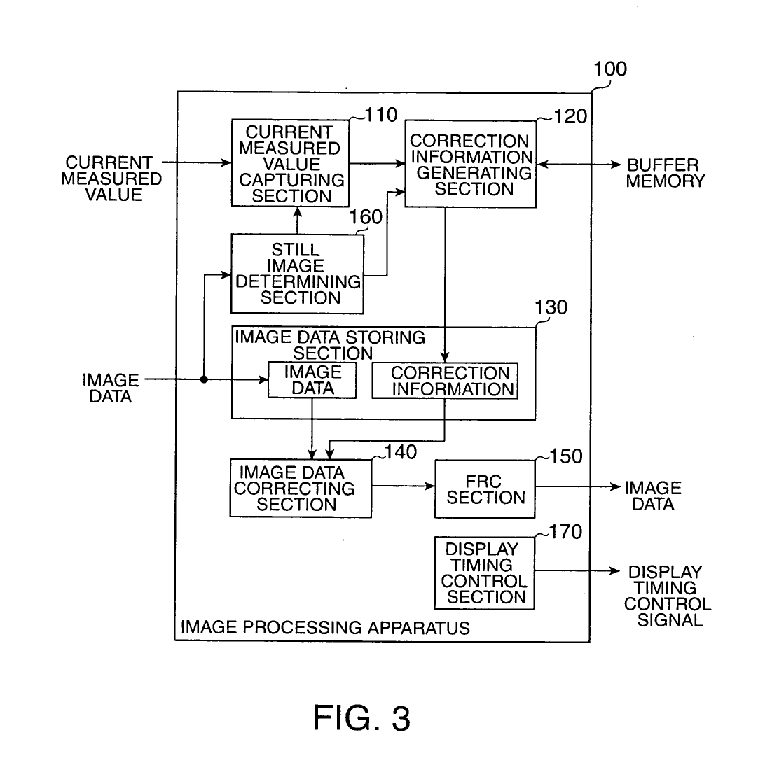

In FIG. 3, a block diagram of a configuration example of the image processing apparatus 100 of FIG. 1 is shown.

The image processing apparatus 100 includes a current measured value capturing section 110 (an operating current value capturing section), a correction information generating section 120 (a correction information generating section), an image data storing section 130, an image data correcting section 140, an FRC section 150, a still image determining section 160, and a display timing control section 170. To the individual sections, a data enable signal DE and a pixel clock DCLK which are generated by the display timing control section 170 are input. The image data from the host 60 is input in synchronization with the pixel clock DCLK. The data enable signal DE is a signal indicating that the image data from the host 60 is valid.

The current measured value capturing section 110 captures the operating current values (or the information corresponding to the operating currents) of the pixels of the display panel 20 one at a time in synchronization with the pixel clock DCLK corresponding to the image data of the display image. At this time, the current measured value capturing section 110 captures, as the operating current value, the current value flowing through the resistance circuit inserted into the power line from the power supply circuit 70 supplying the power supply voltage to the display panel 20. Incidentally, the current measured value capturing section 110 may capture the operating current values of a plurality of pixels in synchronization with the pixel clock DCLK.

The correction information generating section 120 generates correction information based on the operating current value captured by the current measured value capturing section 110. By doing so, optimum correction information according to a color component or the type of the display panel 20 can be generated for the same operating current value, making it possible to perform high-accuracy correction of nonuniform brightness and color unevenness. More specifically, the correction information generating section 120 generates the correction information on the basis of difference information based on a minimum operating current value (information corresponding to a minimum operating current) in one screen, the minimum operating current value of the captured operating current values. The correction information generated by the correction information generating section 120 is stored in the image data storing section 130. As described above, by generating the correction information based on the difference information, it is possible to reduce the amount of information and reduce the capacity to be provided in the image data storing section 130.

In the image data storing section 130, one frame of image data corresponding to the display image from the host 60 is stored one by one and buffered. The image data storing section 130 associates the image data with the correction information generated in the correction information generating section 120 for the pixel corresponding to the image data and stores them.

The image data correcting section 140 performs correction processing on the image data stored in the image data storing section 130 on a color component-by-color component basis based on the correction information stored in the image data storing section 130. Since the correction information is generated based on the operating current value of the light emitting element of the display panel 20, the image data correcting section 140 can perform correction of the image data according to the operating current value of the pixel to be driven.

As a display control section, the FRC section 150 adjusts the lighting time of an OLED by performing FRC on the image data corrected by the image data correcting section 140, and compensates for the steps of gradation lost by correction. More specifically, the FRC section 150 performs control of the lighting time on a pixel-by-pixel basis based on the image data corrected by the image data correcting section 140.

The still image determining section 160 determines whether or not the image data which is stored in the image data storing section 130 is the image data of a still image. For this purpose, the still image determining section 160 detects whether or not there is a series of frames in which an image to be displayed is a still image based on the image data sequentially stored in the image data storing section 130. If it is detected that there is a series of frames which are still images, the still image determining section 160 determines that the image data from the host 60 is the image data of a still image. When the still image determining section 160 determines that the image data is the image data of a still image, the current measured value capturing section 110 performs the above-described processing for capturing the operating current value, and the correction information generating section 120 performs the above-described processing for generating the correction information. Therefore, the image data correcting section 140 performs image data correction processing on the image data of a still image, and the FRC section 150 performs the above-described FRC on the image data of a still image. This makes it possible to prevent deterioration of image quality of moving images by not performing control on moving images on which FRC has little effect and prevent burn-in reliably, and improve the image quality at the time of image display at which the lighting time becomes longer.

The display timing control section 170 generates the display timing control signal. As the display timing control signal, there are, for example, a horizontal synchronizing signal HSYNC specifying one horizontal scanning period and a vertical synchronizing signal VSYNC specifying one vertical scanning period. Furthermore, a start pulse STH in a horizontal scanning direction, a start pulse STV in a vertical scanning direction, the pixel clock DCLK, the data enable signal DE, etc. are also included in the display timing control signal. The display timing control signal generated by the display timing control section 170 is output to the row driver 30 and the column driver 40 in synchronization with the image data subjected to FRC performed by the FRC section 150.

Hereinafter, the details of the image processing apparatus 100 will be described.

[Current Measured Value Capturing Section]

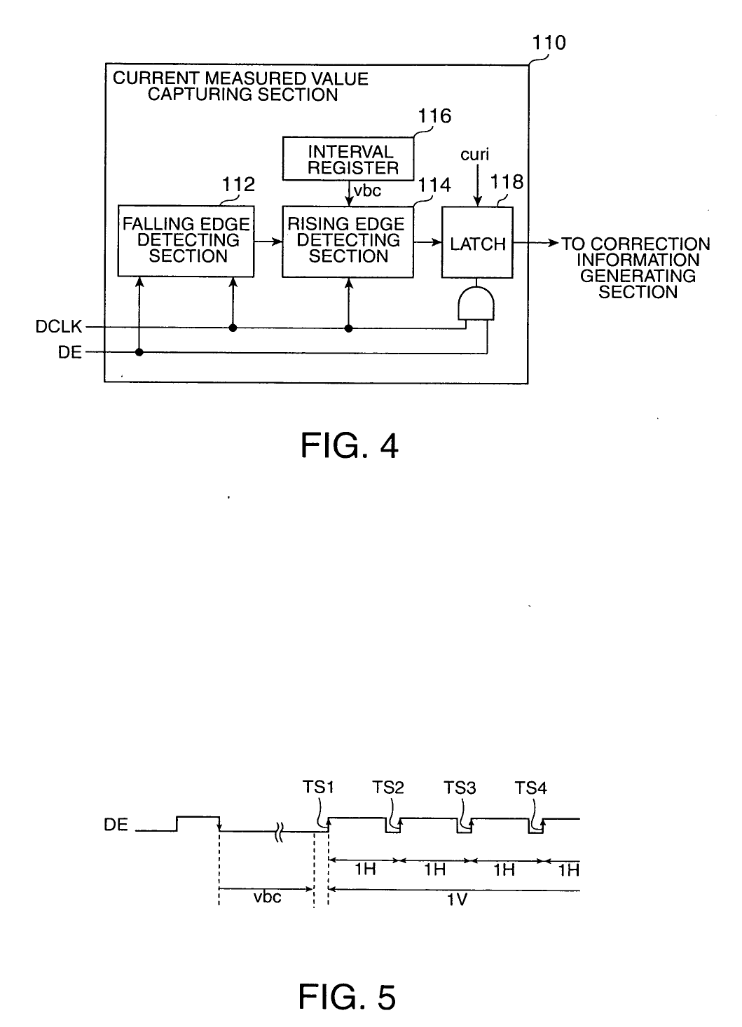

In FIG. 4, a configuration example of the current measured value capturing section 110 of FIG. 3 is shown. Incidentally, in this embodiment, the configuration of the current measured value capturing section 110 is not limited to that shown in FIG. 4.

In FIG. 5, an explanatory diagram of an example of the operation of the current measured value capturing section 110 of FIG. 4 is shown.

The current measured value capturing section 110 includes a falling edge detecting section 112, a rising edge detecting section 114, an interval register 116, and a latch 118. The falling edge detecting section 112 detects the falling edge of the data enable signal DE in synchronization with the pixel clock DCLK. Here, when the data enable signal DE is at H level, the image data output in synchronization with the pixel clock DCLK is assumed to be valid, and, when the data enable signal DE is at L level, the image data is assumed to be invalid. Such a detection result obtained by the falling edge detecting section 112 is supplied to the rising edge detecting section 114. In the interval register 106, control data corresponding to a period in which a vertical blanking period vbc is specified is set by the host 60, for example, and the control data corresponding to the vertical blanking period vbc is supplied to the rising edge detecting section 114.

The rising edge detecting section 114 detects the rising edge of the data enable signal DE in synchronization with the pixel clock DCLK after a lapse of the vertical blanking period vbc. More specifically, the rising edge detecting section 114 detects the rising edge of the data enable signal DE after a lapse of the vertical blanking period vbc after the falling edge of the data enable signal DE is detected by the falling edge detecting section 112. The detection result obtained by the rising edge detecting section 114 is supplied to the latch 118.

To the latch 118, in addition to the detection result obtained by the rising edge detecting section 114, the current value curi converted into a digital value by the A/D converter 76 of FIG. 1, the data enable signal DE, and the pixel clock DCLK are input. Then, when the rising edge of the data enable signal DE is detected by the rising edge detecting section 114, the latch 118 captures the current value curi in synchronization with the AND operation result of the data enable signal DE and the pixel clock DCLK. The current value curi captured by the latch 118 is supplied to the correction information generating section 120 as an operating current value (information corresponding to an operating current).

With this configuration, as shown in FIG. 5, the current measured value capturing section 110 captures the operating current values one at a time in a vertical scanning period which is started after a lapse of the vertical blanking period vbc after the end of the last vertical scanning period at the falling edge of the data enable signal DE. That is, the operating current values for driving the light emitting elements of the pixels to be measured are captured one at a time by sequentially lighting the pixels on a pixel-by-pixel basis, the pixels forming the scanning line to be measured, in this vertical scanning period in a horizontal scanning period which is started at every rising edge of the data enable signal DE.

For example, at measurement timing TS1 of FIG. 5, the operating current value is obtained for each of the pixels forming a scanning line starting from a pixel position (0, 1), and, at the next measurement timing TS2, the operating current value is obtained for each of the pixels forming a scanning line starting from a pixel position (0, 2). Similarly, at measurement timing TS3, the operating current value is obtained for each of the pixels forming a scanning line starting from a pixel position (0, 3), and, at measurement timing TS4, the operating current value is obtained for each of the pixels forming a scanning line starting from a pixel position (0, 4).

[Correction Information Generating Section]

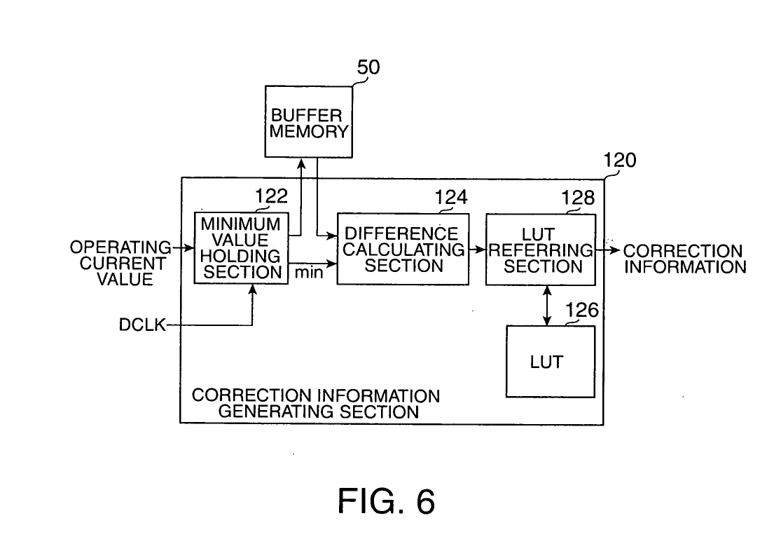

In FIG. 6, a block diagram of a configuration example of the correction information generating section 120 of FIG. 3 is shown. Incidentally, in this embodiment, the configuration of the correction information generating section 120 is not limited to that shown in FIG. 6.

The correction information generating section 120 includes a minimum value holding section 122, a difference calculating section 124, a look up table (Look Up Table: hereinafter LUT) 126, and an LUT referring section 128. To the correction information generating section 120, the operating current values are sequentially input pixel by pixel in one screen in synchronization with the pixel clock DCLK. The minimum value holding section 122 detects a minimum operating current value min of a plurality of operating current values input pixel by pixel in one screen, and holds the minimum operating current value. For example, the minimum operating current value min can be eventually obtained by repeatedly performing, on the plurality of operating current values in one screen, processing for comparing an operating current value of the operating current values input one at a time with the last operating current value and holding a smaller operating current value. Incidentally, the operating current values captured by the current measured value capturing section 110 are sequentially stored in the buffer memory 50.

The difference calculating section 124 performs control of reading, from the buffer memory 50, the operating current value obtained on a pixel-by-pixel basis and calculates a difference value as difference information by subtracting the minimum operating current value min from the operating current value.

In the LUT 126, the difference value from the difference calculating section 124 is stored as an input value, and the correction value of the image data corresponding to the difference value is stored as an output value. By using the difference value from the difference calculating section 124 as an input value, the LUT referring section 128 obtains a correction value corresponding to the input value by referring to the LUT 126. This correction value is associated with the image data of a corresponding pixel and stored in the image data storing section 130 as the correction information. Incidentally, an output value corresponding to an intended input value may be calculated by storing, in the LUT 126, an output value only for a sampled input value and performing, by the LUT referring section 128, well-known interpolation processing by using the output values read for two input values.

The image data correcting section 140 generates the corrected image data by adding, to the image data stored in the image data storing section 130, the correction information corresponding to the image data on a color component-by-color component basis (on a pixel-by-pixel basis). By tolerating a negative correction value also as the correction information, the image data correction processing can be realized by simple addition processing.

[FRC Section]

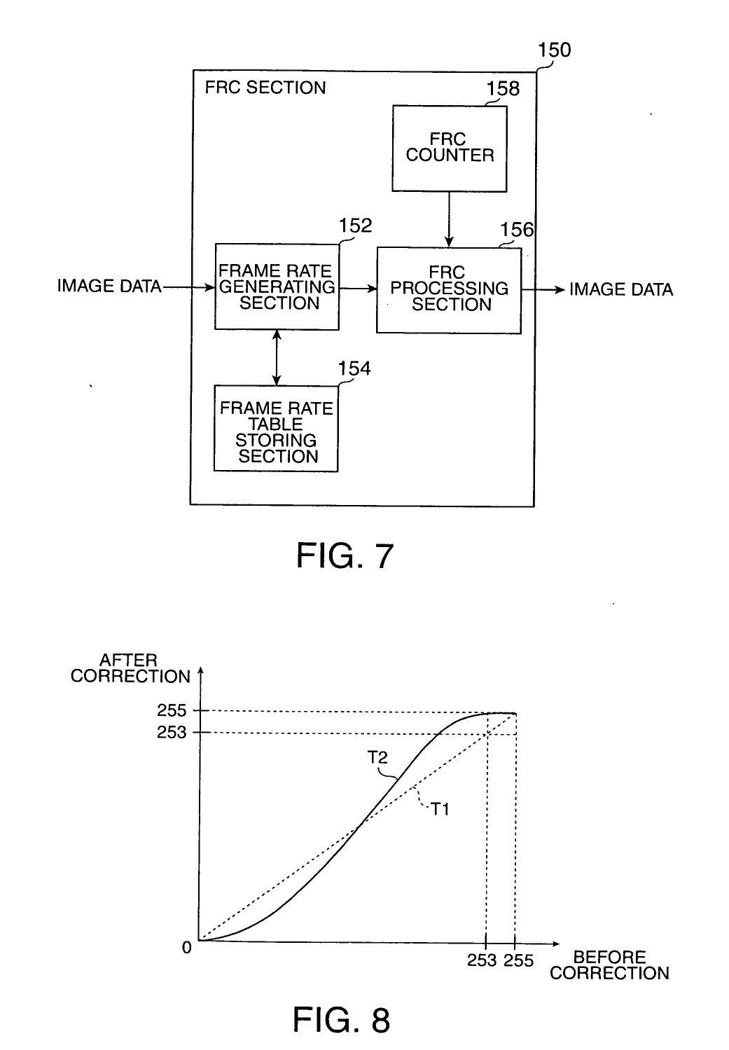

In FIG. 7, a block diagram of a configuration example of the FRC section 150 of FIG. 3 is shown. Incidentally, in this embodiment, the configuration of the FRC section 150 is not limited to that shown in FIG. 7.

The FRC section 150 includes a frame rate generating section 152, a frame rate table storing section 154, an FRC processing section 156, and an FRC counter 158. The frame rate generating section 152 generates, for each color component of each dot, a frame rate corresponding to the image data corrected by the image data correcting section 140. For this purpose, in the frame rate table storing section 154, a frame rate table which is the table of frames to be lit according to the frame rate corresponding to the image data corrected by the image data correcting section 140 is stored for each color component. The frame rate generating section 152 generates a frame rate for each color component, the frame rate by which a frame which is to be lit and a frame which is not to be lit are specified, by referring to the frame rate table stored in the frame rate table storing section 154. The FRC processing section 156 performs lighting control of a light emitting element of an OLED by performing FRC based on the frame rate generated by the frame rate generating section 152, and outputs the image data subjected to FRC. In this way, the FRC section 150 compensates for the steps of gradation lost by correction of the image data performed by the image data correcting section 140. The FRC counter 158 counts the number of frames of an image on which display control is performed, and outputs a frame number FN for identifying the counted frame. The FRC processing section 156 performs FRC by using the frame number FN from the FRC counter 158.

The FRC section 150 having such a configuration operates as follows.

In FIG. 8, a diagram for explaining the operation of the FRC section 150 of FIG. 7 is shown. FIG. 8 shows a horizontal axis representing a gradation value of an R component corresponding to the image data before correction performed by the image data correcting section 140 and a vertical axis representing a gradation value of an R component corresponding to the image data after correction performed by the image data correcting section 140. In FIG. 8, the R component is shown as an example; however, the same goes for a G component and a B component.

So-called gradation loss may occur due to correction of image data performed by the image data correcting section 140. When the image data of each color component of RGB is assumed to be composed of 8 bit data, the image data before correction has chromatic resolving power of 256 steps of gradation (0 to 255-step gradation) for each color component. At this time, as a result of correction performed based on the correction information, it is assumed that, for example, (R, G, B)=(253, 252, 248) is corrected to (R, G, B)=(255, 255, 255). This means that, in FIG. 8, the R component, for example, is converted from T1 to T2 of FIG. 8. In this case, two steps of gradation of the R component are lost, three steps of gradation of the G component are lost, and seven steps of gradation of the B are lost.

Therefore, to realize gradation expression of 256 steps of gradation, one step of gradation of each color component is as follows.

R=254/256≈0.992 (1)

G=253/256≈0.988 (2)

B=249/256 ≈0.973 (3)

Here, to express 192-step gradation of the R component (R192), image data corresponding to a gradation value expressed by the following expression is used by using expression (1).

R192=0.992×192=190.464 (4)

In expression (4), the value is higher than that of 190-step gradation by 0.464. Thus, for 0.464, the FRC section 150 expresses gradation corresponding to the gradation value of expression (4) by displaying 191-step gradation, which is gradation one step higher than 190-step gradation, one frame in a predetermined number of frames Fs. Specifically, the FRC section 150 performs control so as to output the image data corresponding to 191-step gradation one frame in the number of frames Fs, the number determined by using the display time tp of each frame, and output the image data corresponding to 190-step gradation in the remaining frames.

For example, when display is performed at the rate of 60 frames per second, tp, Fr, and Fs are as follows.

tp=1/60≈0.016 (5)

Fr=0.464/tp=0.464/0.016≈29 (6)

Fs=60/Fr=60/29≈2 (7)

At this time, the image data corresponding to 191-step gradation is output one in every two frames, and the image data corresponding to 190-step gradation is output in the remaining frames. That is, in expression (6), the frame rate Fr is obtained. In this embodiment, according to the frame rate Fr, in which frame R191 is output and in which frame R190 is output are specified in the frame rate table.

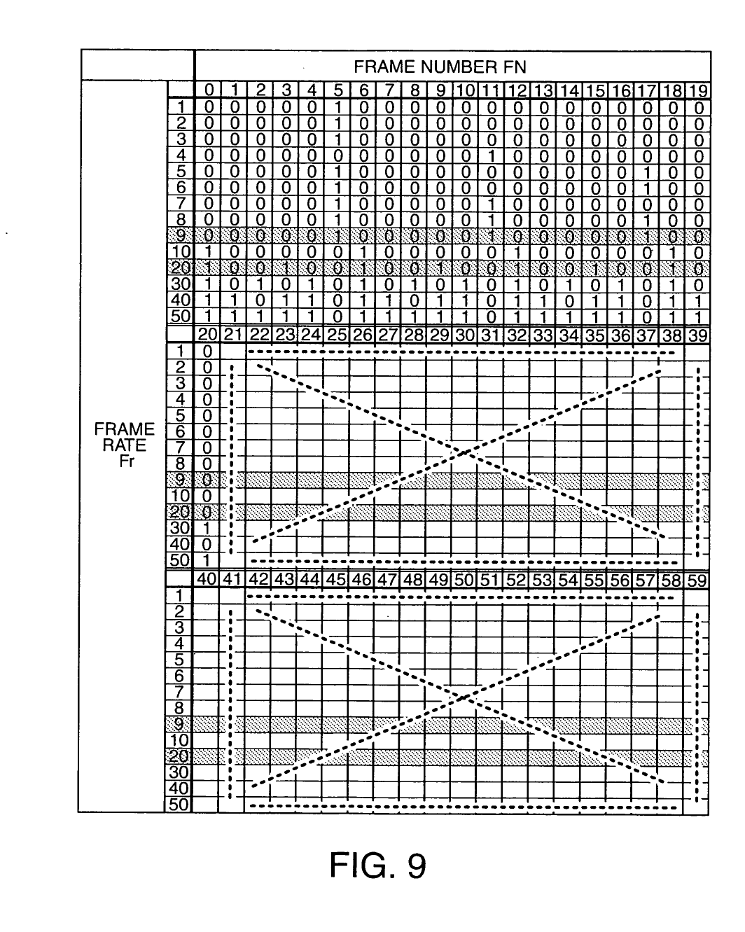

In FIG. 9, an outline of the frame rate table stored in the frame rate table storing section 154 of FIG. 7 is shown. FIG. 9 shows the frame rate table of an R component; however, the frame rate tables of a G component and a B component are the same as the frame rate table of an R component. Incidentally, although in FIG. 9 “1” and “0” are shown in only part of the drawing, “1” and “0” are appropriately set in the remaining parts.

In this frame rate table, gradation (in this case, 191-step gradation) one step higher than certain gradation is specified, the gradation to be displayed in a frame specified by the frame number FN, in accordance with the frame rate Fr when display is performed at the rate of 60 frames per second. For example, when R192 is displayed, since the frame rate Fr is “29”, AND operation of “20” and “9” is performed in each frame. In a frame (a first frame) in which the AND operation result is “1”, the image data corresponding to 191-step gradation (a first gradation value) is output, and, in a frame (a second frame) in which the AND operation result is “0”, the image data corresponding to 190-step gradation (a second gradation value) is output.

Frames in which R191 is output: 0, 3, 5, 6, 9, 11, 12, 15, 17, . . . .

Frames in which R190 is output: 1, 2, 4, 7, 8, 10, 13, 14, 16, . . . .

As described above, the FRC section 150 can output the image data corresponding to the first gradation value in the first frame corresponding to the image data corrected by the image data correcting section 140 and output the image data corresponding to the second gradation value in the second frame.

Incidentally, the frame rate table is not limited to that shown in FIG. 9, and it is necessary simply to adjust the lighting time of an OLED based on the frame rate corresponding to the image data corrected by the image data correcting section 140. Moreover, it is preferable that the storage content of the frame rate table be configured to be changeable by the host 60 or the like.

The image processing apparatus 100 described above may be formed of an ASIC (Application Specific Integrated Circuit) and dedicated hardware, but the function of the image processing apparatus 100 may be realized by software processing. In this case, the image processing apparatus 100 is formed of a central processing unit (Central Processing Unit: hereinafter CPU) and a read only memory (Read Only Memory: hereinafter ROM) or random access memory (Random Access Memory: hereinafter RAM). The CPU which has read a program product stored in the ROM or the RAM executes the processing corresponding to the program product, whereby the function of the image processing apparatus 100 is realized by software processing.

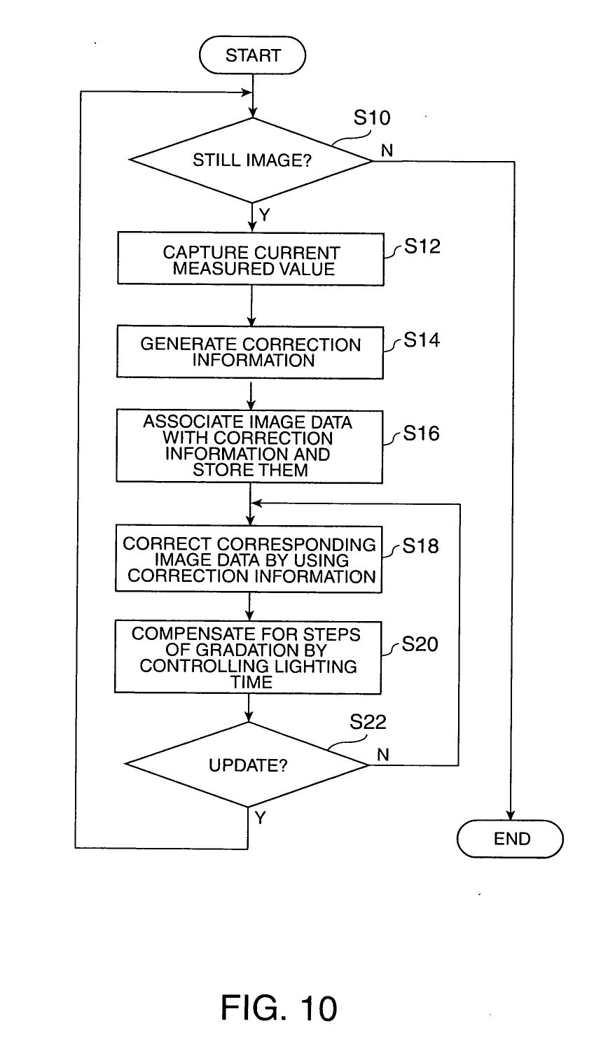

In FIG. 10, a flow diagram of an example of processing performed by the image processing apparatus 100 is shown. When the image processing apparatus 100 is formed of hardware, the hardware corresponding to the individual parts of FIGS. 3, 4, 6, and 7 can execute the processing corresponding to the steps of FIG. 10. Alternatively, when the function of the image processing apparatus 100 is realized by software processing, the procedure of FIG. 10, a program product is stored in the ROM or the RAM, and the CPU which has read the program product executes the processing corresponding to the program product.

First, as a still image determining step, the image processing apparatus 100 determines whether or not the image data from the host 60 is the image data of a still image (step S10). If it is determined in step S10 that the image data is the image data of a still image, the image processing apparatus 100 captures the operating current values of the pixels of the display panel 20 one at a time as a current measured value capturing step (step S12). Then, as a correction information generating step, the image processing apparatus 100 generates the correction information based on the operating current values captured in step S12 (step S14). At this time, the image processing apparatus 100 generates the correction information on the basis of the difference information based on a minimum operating current value in one screen, the minimum operating current value of the captured operating current values, associates the correction information with the corresponding image data, and stores them in the image data storing section 130 (step S16).

Then, by using the correction information generated in step S14 and stored in step S16, the image processing apparatus 100 corrects the corresponding image data on a color component-by-color component basis as an image data correcting step (step S18). As a result, the image processing apparatus 100 can correct variations in an OLED and a drive current driving the OLED concurrently and reduce nonuniform brightness and color unevenness with a high degree of accuracy.

Next, as a display control step (a gradation step number compensating step), the image processing apparatus 100 performs processing for compensating for the steps of gradation lost in step S18 by performing control of the lighting time on a pixel-by-pixel basis based on the image data corrected in step S18 (step S20). More specifically, in step S20, FRC is performed on a color component-by-color component basis at a frame rate corresponding to the image data corrected in step S18, and the image data subjected to FRC is output.

Here, if the image data is updated (step S22: Y), the image processing apparatus 100 goes back to step S10 and continues the same processing on the updated image data. On the other hand, if the data is not updated in step S22 (step S22: N), the image processing apparatus 100 goes back to step S18 and outputs the image data subjected to FRC described above in synchronization with the display timing control signal generated in the display timing control section 170.

If it is determined in step S10 that there is no image data of a still image (step S10: N), the image processing apparatus 100 ends a series of processing (END).

As described above, according to this embodiment, by correcting the corresponding image data based on the operating current value of a pixel, it is possible to correct variations in an OLED and a drive current driving the OLED concurrently and reduce nonuniform brightness and color unevenness with a high degree of accuracy.

Moreover, since the frame rate is adjusted on a pixel-by-pixel basis based on the corrected image data, it is possible to compensate for gradation loss caused by correction of the image data and compensate for the shortage of steps of gradation.

The display system 10 including the image processing apparatus 100 described above can be applied to the following electronic apparatus, for example.

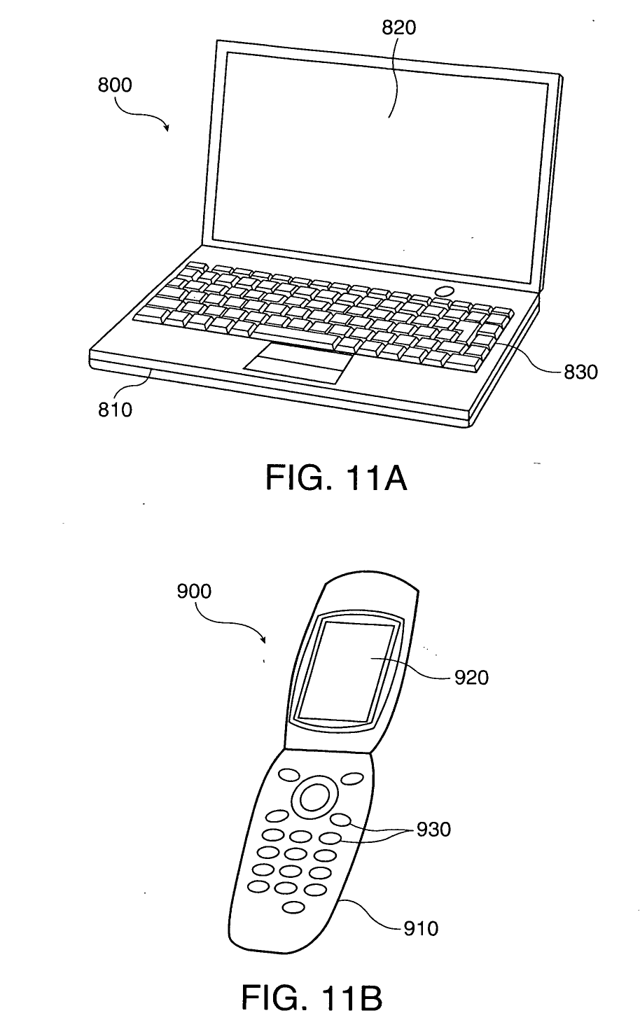

In FIGS. 11(A) and 11(B), perspective views showing the configurations of electronic apparatuses to which the display system 10 in this embodiment is applied are shown. FIG. 11(A) is a perspective view of the configuration of a mobile personal computer. FIG. 11(B) is a perspective view of the configuration of a mobile telephone.

A personal computer 800 shown in FIG. 11(A) includes a main body section 810 and a display section 820. As the display section 820, the display system 10 in this embodiment is implemented. The main body section 810 includes the host 60 of the display system 10, and a keyboard 830 is provided in the main body section 810. That is, the personal computer 800 includes at least the image processing apparatus 100 in the embodiment described above. The operating information via the keyboard 830 is analyzed by the host 60, and an image is displayed in the display section 820 according to the operating information. Since the display section 820 uses an OLED as a display element, it is possible to provide the personal computer 800 with a screen having a wide viewing angle.

A mobile telephone 900 shown in FIG. 11(B) includes a main body section 910 and a display section 920. As the display section 920, the display system 10 in this embodiment is implemented. The main body section 910 includes the host 60 of the display system 10, and a keyboard 930 is provided in the main body section 910. That is, the mobile telephone 900 includes at least the image processing apparatus 100 in the embodiment described above. The operating information via the keyboard 930 is analyzed by the host 60, and an image is displayed in the display section 920 according to the operating information. Since the display section 920 uses an OLED as a display element, it is possible to provide the mobile telephone 900 with a screen having a wide viewing angle.

Incidentally, an electronic apparatus to which the display system 10 in this embodiment is applied is not limited to those shown in FIGS. 11(A) and 11(B). For example, some examples of such an apparatus are personal digital assistants (PDAs: Personal Digital Assistants), digital still cameras, televisions, video cameras, car navigation devices, pagers, electronic organizers, electronic paper, calculators, word processors, workstations, video telephones, POS (Point of sale system) terminals, printers, scanners, copiers, video players, and apparatuses provided with a touch panel.

The image processing apparatus, the display system, the electronic apparatus, the method of processing an image, etc. according to the invention have been described based on the embodiment described above; however, the invention is not limited by the embodiment described above. For example, the invention can be implemented in numerous ways within the scope of the subject matter of the invention, and the following modifications are possible.

(1) In this embodiment, descriptions have been given by taking up, as an example, the display system to which an OLED is applied; however, the invention is not limited by this example.

(2) In this embodiment, descriptions have been given by taking up, as an example, the image data in RGB format; however, the invention is not limited by this example. For example, the image data may be image data in YUV format or other formats.

(3) In this embodiment, the invention has been described as an image processing apparatus, a display system, an electronic apparatus, a method of processing an image, etc.; however, the invention is not limited thereto. For example, the invention may be a program product in which the procedure of the above-described method of processing an image is described or a recording medium in which the program product is recorded.

1. An image processing apparatus performing display control based on image data corresponding to each of pixels forming a display image, comprising:
an image data correcting section correcting the image data of each pixel based on information corresponding to an operating current of each pixel; and
a display control section compensating for steps of gradation lost by correction performed by the image data correcting section by adjusting the lighting time of each pixel.

2. The image processing apparatus according to claim 1, wherein
the display control section adjusts the lighting time of the pixel according to the image data corrected by the image data correcting section.

3. The image processing apparatus according to claim 2, wherein
the display control section outputs image data corresponding to a first gradation value in a first frame corresponding to the image data corrected by the image data correcting section and outputs image data corresponding to a second gradation value in a second frame.

4. The image processing apparatus according to claim 2, wherein
the display control section includes a frame rate table storing section storing a frame rate table in which a frame to be lit is set according to a frame rate corresponding to the image data corrected by the image data correcting section, and
the display control section performs lighting control of the pixel based on the frame rate table.

5. The image processing apparatus according to claim 4, wherein
the frame rate table storing section stores the frame rate table for each of color components forming one dot, and
the display control section performs lighting control of a pixel of each color component based on the frame rate table stored for each color component.

6. The image processing apparatus according to claim 1, wherein
the image data correcting section corrects the image data of each pixel on the basis of difference information based on a minimum operating current of operating currents of the pixels in one screen.

7. The image processing apparatus according to claim 1, wherein
the display control section compensates for steps of gradation lost by correction of the image data performed by the image data correcting section when the display image is a still image.

8. A display system, comprising:
a display panel including a plurality of row signal lines, a plurality of column signal lines provided so as to intersect the plurality of row signal lines, and a plurality of pixels, each having a light emitting element which is identified by any one of the plurality of row signal lines and any one of the plurality of column signal lines and emits light at brightness according to a drive current;
a row driver driving the plurality of row signal lines;
a column driver driving the plurality of column signal lines; and
the image processing apparatus according to claim 1, wherein
the display system displays the display image based on the image data on which display control has been performed by the image processing apparatus.

9. An electronic apparatus, comprising:
the image processing apparatus according to claim 1.

10. A method of processing an image, the method by which display control is performed based on image data corresponding to each of pixels forming a display image, comprising:
an image data correcting step of correcting the image data of each pixel based on information corresponding to an operating current of each pixel; and
a display control step of compensating for steps of gradation lost by correction of the image data performed in the image data correcting step by adjusting the lighting time of each pixel.

11. The method of processing an image according to claim 10, wherein in the display control step,
lighting control of the pixel is performed according to the image data corrected in the image data correcting step.

12. The method of processing an image according to claim 11, wherein
in the display control step,
image data corresponding to a first gradation value is output in a first frame corresponding to the image data corrected in the image data correcting step, and image data corresponding to a second gradation value is output in a second frame.
